(19) United States
(12) Patent Application Publication
(10) Pub. No.: US 2008/0167903 A1
(43) Pub. Date: Jul. 10, 2008

(54) SYSTEM AND METHOD FOR PROVIDING INSURANCE AND FINANCIAL BENEFITS

(76) Inventors: Cory Hall, Murray, UT (US); Joel Harrison, Salt Lake City, UT (US)

Correspondence Address: THORPE NORTH & WESTERN, LLP., P.O. Box 1219, SANDY, UT, 84091-1219, US

(21) Appl. No.: 11/620,612

(22) Filed: Jan. 5, 2007

(51) Int. Cl. G06Q 40/00

(52) U.S. Cl. 705/4

(57) ABSTRACT

A system and method of supplying insurance and financial benefits is provided. The method can include the step of entering into an insurance contract between a policyholder and an insurance provider. A beneficiary can be identified to be insured under the insurance contract and to receive selected benefits based on a significant health event for the policyholder. The selected benefits can be provided to the beneficiary upon an occurrence of the significant health event of the policyholder.

### FIELD OF THE INVENTION

The present invention relates generally to insurance and financial benefits.

### BACKGROUND

Insurance is a business that has been built around the need for individuals to protect themselves and their families against property loss or other financial problem situations. Such insurance coverage is particularly helpful in situations where the user may not otherwise be prepared for or be able to bear unexpected financial costs. Examples of situations where insurance may provide significant financial advantages include the areas of automotive insurance, health insurance or life insurance.

Many individuals live from paycheck to paycheck and do not have money to be “self insured”. These people generally desire to be insured against a catastrophic event such as a car accident or death. An insurance arrangement allows an individual to pay a monthly sum to the insurance provider to protect against such events.

By insuring a large group of individuals, an insurance provider is able to distribute the risk over many individuals who are paying the insurance provider to cover the defined risk. Because a single individual cannot know when or where a loss event is going to occur, the cost distribution of a possible loss over a large group of policyholders is valuable to society as a whole. This is because the insurance provider can pay for the individual loss with the funds accumulated over a period of time from a larger group of individuals. As a result, neither the individual nor other service providers in society (e.g., such as hospitals, governments, mortuaries, etc.) will have to bear the cost of unexpected accidents, death, or other financial loss.

As an example, life insurance is protection against financial loss resulting from death. It is an insurance provider's promise to pay a specified beneficiary a defined amount of money when the policyholder dies in exchange for timely payment of premiums in advance of the death. It can be a significant asset to use life insurance to help replace lost income in the event of a premature death.

There are many reasons that individuals may buy life insurance. For example, a purchaser may desire to replace income a family would need to maintain their standard of living after the death of a wage earner. The life insurance can also be provided to pay off a mortgage loan, pay burial costs, pay debts, or to create a trust fund.

### SUMMARY OF THE INVENTION

A system and method of supplying insurance and financial benefits is provided. The method can include the step of entering into an insurance contract between a policyholder and an insurance provider. A beneficiary can be identified to be insured under the insurance contract and to receive selected benefits based on a significant health event for the policyholder. The selected benefits can be provided to the beneficiary upon an occurrence of the significant health event of the policyholder.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram illustrating a system for providing insurance and financial benefits in accordance with an embodiment of the present invention;

FIG. 2 is a block diagram illustrating a system for providing insurance and financial benefits using a credit account in accordance with an embodiment; and

FIG. 3 is a block diagram illustrating a system for providing insurance and financial benefits using a benefits manager in accordance with an embodiment;

FIG. 4 is a block diagram illustrating a system for providing insurance and financial benefits using a centralized underwriter in accordance with an embodiment of the invention;

FIG. 5 is a flowchart illustrating a method for providing insurance and financial benefits in accordance with an embodiment; and

FIG. 6 is a flowchart illustrating a method for providing insurance and financial benefits in accordance with an embodiment of the invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

A system and method are described for providing insurance and financial benefits. The insurance described here is to provide closure for individuals who are concerned that they may have a serious health event happen in their lives and desire to have friends or loved ones in near proximity to them during or after that time period. An example of this situation is where an older person has children who do not need direct financial support but may those children not have cash reserves to travel to a location of the parent for an unexpected health event. A similar situation exists where an individual has dependent children who do not live with the parent but the parent would like the child to travel to visit them in the event of a serious health problem.

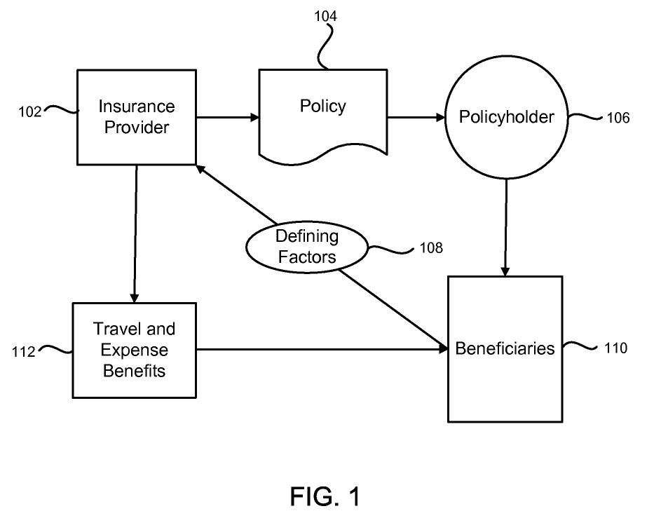

FIG. 1 illustrates an insurance system with an insurance provider 102 that is capable of underwriting a closure investment insurance instrument or closure policy 104. A policyholder 106 is designated in the closure investment insurance instrument, which is purchased from the insurance provider.

The insurance can be purchased by paying periodic payments (e.g. monthly, bimonthly, annual) to the insurance provider for a defined period of time or the policyholder can pay a defined lump sum in advance to receive the benefits. For example, monthly or bimonthly automatic withdrawals may be made from a policyholder's bank account. Depending on the age of the policyholder, a lump sum payment can be used to activate the insurance for a specific period of time or if the lump sum is large enough the insurance policy may be paid up until a critical health event occurs.

One or more beneficiaries 110 can be designated in the closure investment insurance instrument by the policyholder 106 to receive benefits upon a significant health event. The list of beneficiaries can be included in the insurance contract and may be amended when the beneficiaries change. A policy may also define the number of beneficiaries that are being paid for under a given policy.

For example, a policyholder is likely to select his children or other younger relatives as beneficiaries. However, the beneficiaries list is not limited to relatives but may include friends, business partners or others that the policyholder desires to travel to visit the policyholder at their current location (e.g, home or hospital) in the event of a significant health event. The policy may state that a limit of three individuals (e.g. people close to the policyholder) can be beneficiaries under the policy. In the situation where the policyholder has several children, who have changing financial circumstances, then the policyholder may drop children who become financially independent and add children who have recently left home. Alternatively, the beneficiary list may be a contingent list based on certain criteria such as a minimum personal income amount or whether a beneficiary has visited the policyholder within the last three years.

As used herein, “a significant health event” is defined as an event where the policyholder has a serious illness, critical illness, serious accident, or critical accident. Examples of this might be a stroke, life threatening accident, or cancer. How the significant health event is specifically defined may be based on a number of defining factors 108 in the insurance contract itself.

For example, when a critical illness is a defining factor, then the insurance contract may require that the policyholder be in a hospital. In another embodiment, the insurance contract may not require any hospitalization but may just require that policyholder make a request for the benefits based on a policyholder's knowledge of their diagnosed health condition. The policy may also limit the number of times such a request can be made to just once or twice in the policy restrictions. The term significant health benefit as defined herein does not include an actual death, as that situation can be covered by a separate policy or separate rider in the closure investment policy.

In an additional embodiment of the invention, the triggering event for the insurance may be defined as “a crisis event”. The crisis event is defined herein as an event that incapacitates or significantly affects the quality of life of individual who has been insured for the crisis event. In many cases the individual who is insured to be covered by the crisis event will be the policyholder, but the insured individual may also be another family member or a business partner.

Some specific benefits that can be provided for the beneficiaries upon the occurrence of a significant health event can include travel expenses to the location of the policyholder and defined expenses 112 that are selected upon entering the contractual insurance relationship. Alternatively, the travel expenses may be covered for traveling to see a person who is related to the policyholder. The selected benefits as described herein can cover an entire plane ticket from anywhere in the world to the location of the policyholder as defined in the contract. Other travel expenses may include car rental or ground transportation costs, hotel costs or lodging for a defined period of time, food expenses for a defined period of time, incidental charges, a cash stipend, or other travel related costs.

Other defined expenses can be provided to the beneficiaries as specifically written into the contract. For example, defined expenses that can be included in the policy are defined herein to include: caring for a physically or mentally impaired family member of the beneficiaries, a defined need to provide care or support for an individual, the actual or estimated cost of lost work time or lost income, temporary relocation costs, moving costs, and other special needs for the beneficiaries can be covered if arranged and paid for as part of the policy agreement. Other special needs can include a lump sum of money that is expected to be needed to help the beneficiaries resolve personal estate and legal issues for the policyholder. In addition, the insurance policy can provide the money needed to transport the policyholder's body home after the policyholder has died.

The benefits provided to a beneficiary can be prioritized for payment with respect to a total sum of money that is allowed to be paid under the insurance policy. In other words, if there is a $10,000 limit for the policy then the highest priority items on a policyholder's prioritized benefits list can be paid for first and then the beneficiary may have to pay for any other needed travel items out of their own pocket.

A significant result of having and using closure investment insurance is that is provides peace of mind to a beneficiary in a time of crisis. Since the beneficiary can call a benefits provider or manager to make the travel arrangement for the beneficiary, this relieves the beneficiary of a significant amount of personal stress in arranging all of the travel and related issues when the crisis occurs. Just being able to avoid the simple but time consuming problems associated with booking and arranging travel can make life easier for the beneficiary during the crisis period. Knowing that someone else will take care of travel and all the related matters allows the beneficiary to focus on the crisis at hand and being able to focus on the crisis enables the beneficiary to more fully realize the emotional and spiritual closure that they need. In addition, the beneficiary does not have to worry about any financial burdens that may come with making travel arrangements.

These policy benefits may be provided to those who are not expected to have the resources to travel to see the policyholder at the time an unexpected health event occurs. The insurance policy allows the beneficiaries to come and see the policyholder while the policyholder is seriously ill, critically ill, or may be expected to die in the near future. This type of visit can provide emotional closure for the beneficiaries, the policyholder and other family members of the policyholder.

The closure investment insurance is structured to provide assistance to beneficiaries in the time of a crisis or significant health event for the policyholder. As a result, when beneficiaries call and request the travel services and related benefits for which the policyholder has taken out a policy, then the benefit of the doubt will be on the side of the beneficiaries and the benefits provider will make every effort to grant the requests of the beneficiaries. As such, confirming that a significant health event or a triggering event has occurred may be performed by having the benefit provider just make short telephone calls to verify that there is reason to believe that a trigger event has occurred. This means that the benefits provider will make every reasonable effort to provide the benefits to the beneficiary, as opposed to trying to make technical disqualifications or excuses. This inclusive policy view avoids placing additional burdens of proof on the beneficiary at a time when they are already under emotional, spiritual and possible financial stress.

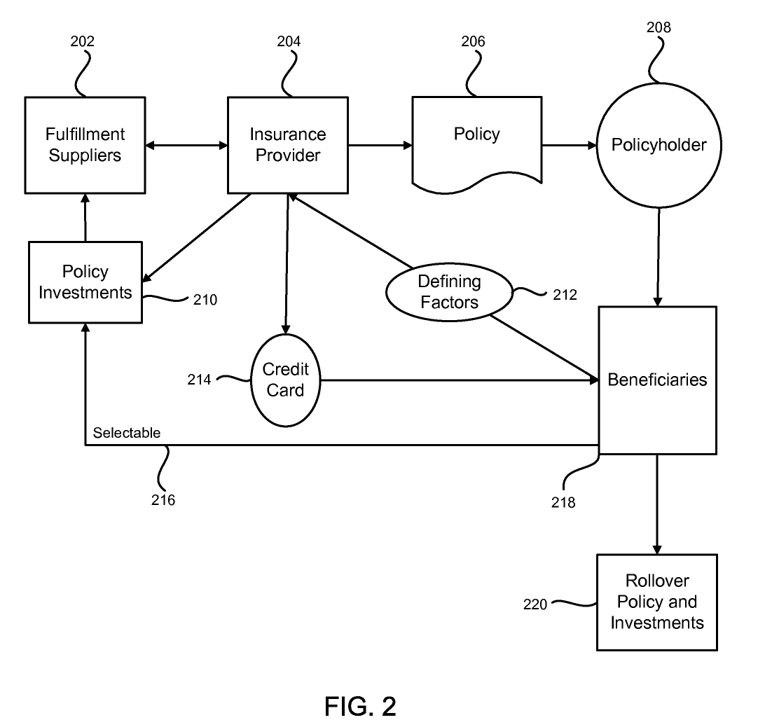

FIG. 2 illustrates an additional embodiment of the system where the insurance provider 204 has arranged for certain administration mechanisms to provide the fulfillment of the policy 206 for the policyholder 208. One method of administration is to provide a credit account, credit card, or debit card 214 to the beneficiary 218 in order to pay the travel expenses and defined expenses. This credit card or debit card may allow only certain types of services to be charged on the card up to a certain amount. For example, the services that the credit card may allow to be charged on the card may include plane flights, hotels, restaurant meals, rental cars, and other products and services directly associated with travel. Of course, a credit or debit card without these purchase restrictions may be provided.

In an additional embodiment of the invention, the credit account or debit card may be provided with a periodic or daily allowance of credit or cash. This periodic or daily allowance of credit and/or cash can be added to the account by the benefits manager as the beneficiary uses the funds for the defined expenses. This allows the benefits manager to monitor how the funds are spent and limits the rate at which the funds can be spent. Limiting the disbursement of the funds also helps guard against a beneficiary who might waste the funds by spending the funds on items that are unrelated to the purpose of the insurance policy.

A plurality of fulfillment suppliers 202 may be contracted with by the insurance provider to supply contracted travel and additional services. This enables the insurance provider to aggregate the costs associated with fulfilling the insurance policy and reduce the overall costs for fulfilling the last minute travel arrangements. By negotiating for the services that the insurance provider knows in advance will be needed, this allows the costs to be reduced and some of the cost reductions translate to cost savings for the insured policyholder and/or increased profits for the insurance provider.

FIG. 2 further illustrates that a portion of premiums paid to maintain the insurance contract can be placed into an interest bearing investment 210 for the beneficiaries. These investments may be selected and modified by the beneficiaries or policyholder and can include investments such as stocks, bonds, commodities, hedge funds, annuities, and the like. When the investments are selected, the policyholder can also select the amount of risk that is inherent in the selected investments.

While the name insurance described here is “closure investment insurance”, this name is not meant to imply that the closure investment insurance is required to have an investment account as part of the policy because an investment component for an insurance policy is not required. The term “investment” in the name of the insurance is meant to imply that policyholders can make an investment by paying premiums to insure that their beneficiaries under the policy have emotional closure in the event of crisis.

In order to make it easier for individuals to pay the monthly payments, arrangements can be made by the policyholder to have weekly, monthly, or quarterly payments paid using payroll deductions. In this situation, a group policy for providing the insurance may be provided through the employer. This allows insurance companies to promote the insurance through employers because it gives employees a peace of mind that their family or close friends will have closure if the policyholder is seriously ill or dies.

By paying policy premiums using employer deductions, the money invested in the insurance policy is better protected from taxes, lawsuits, and probate problems. Regardless of how the policyholder pays for the closure investment insurance benefits, these benefits are also separate from the overall estate of the individual.

The periodic insurance premium payments can be applied in different ways. In one option, the periodic payments may be used to first pay for the closure investment insurance coverage. In most situations, the initial payments will activate the full benefits of closure investment insurance coverage but this may vary from plan to plan. Once the insurance coverage has been paid, then all or part of the insurance payments can be applied to an investment account. For example, it may take one to five years to have paid enough money to cover the entire closure investment insurance amount. When this has been paid, payments may be made that are applied to the investment account. Alternatively, during several months of the year payments may cover the closure investment insurance and the remaining months of the year can contribute to an investment account.

In another embodiment, the monthly insurance premiums may be split and applied to two or more accounts. For example, a first portion of monthly insurance premiums can be applied to pay for closure investment insurance coverage and a second potion of the monthly insurance premiums can be directed to an investment account. This way an investment balance is building up for the entire term during which premium payments are made.

Some premium payments or portions of payments can be provided to cover life insurance. For instance, one or two monthly payments per year can cover life insurance for the policyholder, while the remaining payments cover the closure investment insurance and other investments or annuities. The life insurance can be arranged to cover just accidental death or death by natural causes of the policyholder.

After a claim is made, a beneficiary 218 may also be allowed to transfer or roll-over 220 any remaining amount of a lump sum remaining in a policy to a new insurance policy after payment of a claim. This allows a beneficiary to assume the role of the policyholder, while potentially avoiding taxable events. Alternatively, the beneficiary may assume the role of the policyholder after payment of a claim. This means the beneficiary can replace the policyholder when the original benefits of the policy have been used up or if the beneficiary dies.

Enabling beneficiaries to roll over the value of their policy is also a benefit to the insurance companies because it enables the insurance company to retain customers without paying for sales and advertising costs. This way the cost of the overall closure investment insurance can remain low. In addition, the insurance companies have the opportunities for such insurance policies to remain in place perpetually. When the beneficiaries become policyholders, then the premiums will continue to be paid because the beneficiaries were happy with the policy because it was redeemed during a crisis.

If the beneficiary does not desire to have any remaining monetary value related to travel arrangements or insurance investments rolled over, then the beneficiary can choose to have the monetary benefits paid to them directly. This can be considered a cash-out option. In an alternative embodiment, a legal will may direct who receives certain amounts of cash values that remain in the policy. In another embodiment, instead of cashing out the investment funds or other monetary value, the money can be transferred to an annuity for any of the beneficiaries or for the policyholder's widow or widower.

Some conditions may be placed upon the beneficiaries of the policy. For example, the beneficiary may be required to actually visit the policyholder in the case of a significant health event if the beneficiary desires to receive the benefits of the policy. In other words, the beneficiaries will not be allowed to take the benefits and just go on vacation with the benefits. In a similar manner, the beneficiary may be required to attend the funeral of a deceased policyholder to receive the benefits.

The monetary value of the selected benefits can be adjusted to cover inflation or increased costs of living relative to the value of travel and defined expenses based on an inflation adjustment value. When the monetary values of the selected benefits are increased, this change may also increase the monetary value of the premium to be paid by the policyholder. If a premium has already been paid in full, then the insurance company can cover any offsets to inflations with investments the insurance company has made in anticipation of covering the policy. In one embodiment, a portion of the premiums paid for the insurance can be invested by the insurance company to yield a lump sum of investment principle to pay for the travel and defined expenses that will be paid for upon the occurrence of a significant health event.

While the policyholder has been described in some examples herein as being a parent, other individuals may also act as a policyholder. For example, a child may be the policyholder and insure the parent to travel to see the child if the child has a pre-defined crisis or significant health event. Alternatively, the child may insure themselves to travel to see a parent or person who is close to them. This way the child is paying the premiums for the insurance. In this example, the policyholder and the beneficiary end up being the same person. In another embodiment, a third party can be the policyholder who pays the premiums to cover bringing two individuals together in the time of a crisis.

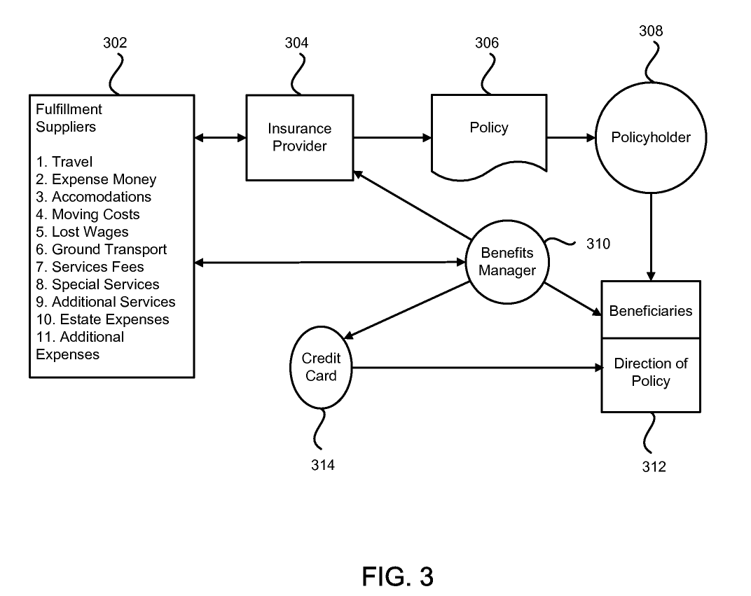

FIG. 3 illustrates that a benefits manager 310 can be appointed by the insurance provider 304 to administer the distribution of the travel expenses and defined expenses for the insurance provider. This means that the insurance company may have an internal group, external group, or third party that manages the distribution of these benefits on a full-time basis. When an unexpected health event occurs to a policyholder 308, then the beneficiaries may be able to call a toll-free number and the benefits management group or manager can begin making the travel arrangements for the beneficiary. This travel can then be arranged by the benefits management group through the fulfillment suppliers 302 that have been selected in advance.

Having a benefits manager not only provides cost savings with the fulfillment suppliers, but it also provides the beneficiary with someone to make the needed arrangements without placing additional undue stress on the beneficiary. The fulfillment suppliers can include travel agents, airlines, hotels, car rental agencies, ground transportation services, service suppliers and restaurant chains, who have contracted in advance to provide discounted services when the fulfillment of the policy 306 takes place. The fulfillment suppliers can provide services such as time-sensitive travel, plane tickets, ground transportation, financial services, moving services, accommodations, and other related services. The benefits manager can also issue a credit or debit card 314 to the beneficiaries to provide the benefits under the insurance contract. This allows the beneficiary to take care of the immediate travel and related needs without any worry or confusion. As mentioned, the beneficiaries will have a peace of mind that the travel details and costs will be taken care of quickly and with a minimum amount of hassle.

The policy can list a number of policy beneficiaries 312 as discussed earlier and the policy can include a direction of policy regarding how the policy benefits should be paid. This may also include the list of contingent beneficiaries. The direction of policy can also address what will happen to any monetary value in the policy in the event of the policyholder's death. For example, the policy may state that the monies should be distributed as directed by the policyholder's will or in ratio to the money paid to the beneficiaries under the policyholder's written will. These directions in the insurance policy may be updated periodically or the insurer may request that the policyholder update the directions every year.

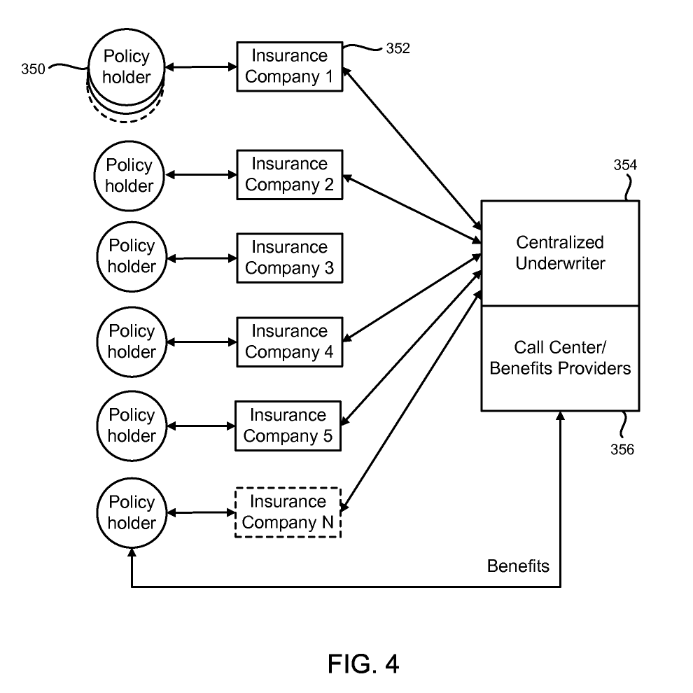

FIG. 4 illustrates an alternative organization for the system for providing insurance and financial benefits. In particular, each separate insurance company 352 may have one or more policyholders 350 who have obtained closure investment insurance through the insurance company. Each insurance company may then be underwritten by a centralized underwriter 354 which maintains the funds necessary to fulfill the benefits as described previously. An unlimited number of insurance companies (1-N) may be underwritten by the centralized underwriter. The centralized underwriter may also make and manage the financial investments as selected and paid for by the policyholders.

The centralized underwriter may maintain a call center and/or benefits manager 356, which provides the benefits when a claim is received from the policyholder. As mentioned before, the call center and benefits manager may either be a part of the underwriting organization or be a third party that is contracted to provide the relevant benefit fulfillment. In another embodiment of the system, a group of insurers may group together to use the same contracted benefits supplier or benefits manager with or without a central underwriter.

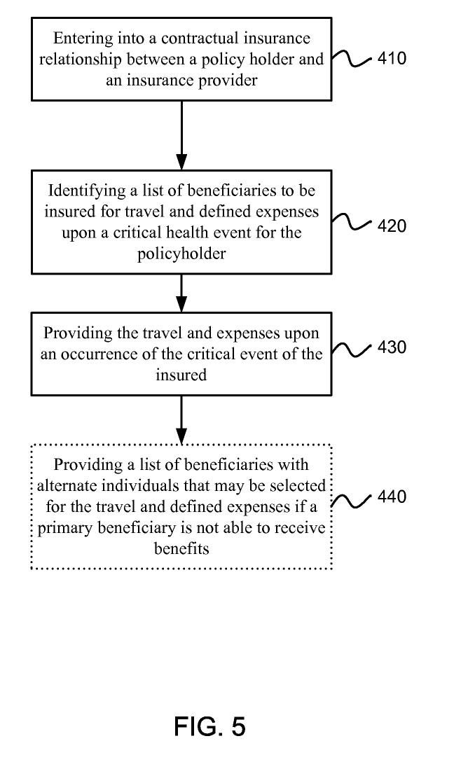

FIG. 5 illustrates a flowchart for a method of providing insurance and financial benefits. The method includes the procedure of entering into an insurance contract between a policyholder and an insurance provider, as in block 410. This relationship may be arranged by the insurance provider or through a third party insurance salesperson. A list of beneficiaries to be insured can also be identified under the insurance contract and to receive selected benefits upon a significant health event for the policyholder, as in block 420.

When a significant health event occurs for the policyholder, then the selected benefits can be provided to the beneficiary, as in block 430. These benefits can be the travel expenses and defined expenses that are selected by either the policyholder or beneficiary upon entering into the insurance contract. Alternate individuals, in addition to the list of primary beneficiaries, can be designated, as in block 440. The alternate individuals can be designated to receive benefits and replace one or more primary beneficiaries who are not able to receive or do not desire the benefits.

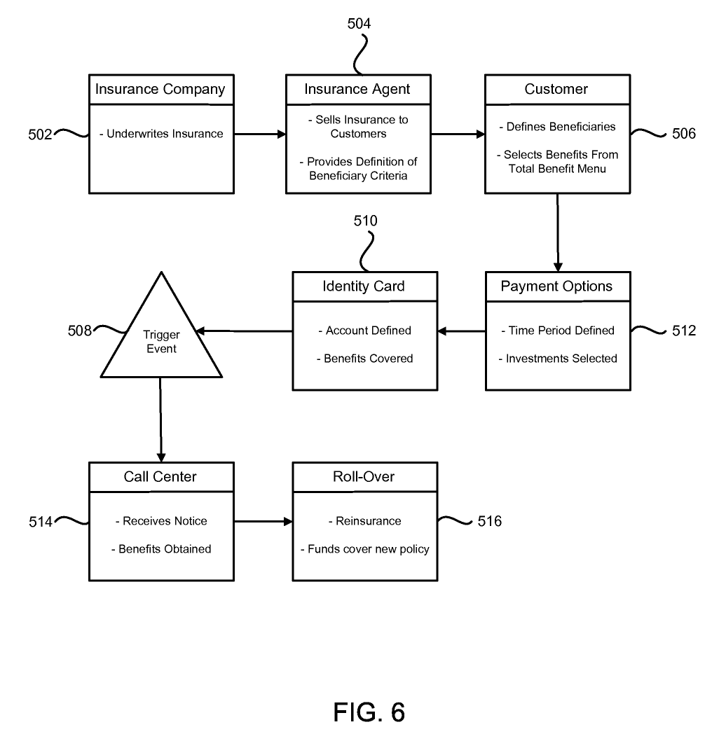

FIG. 6 is a flowchart illustrating a more detailed listing of entities and the procedures they may perform in providing, using, and fulfilling the closure investment insurance. In order to provide the insurance, an insurance company 502 or similar financial institution can decide that they are willing to underwrite the closure investment insurance.

The insurance company may employ an insurance agent 504 or another entity who will sell the insurance. The insurance may also be sold via infomercials, through membership organizations (e.g., AARP), or directly over the Internet. The insurance agent can collect the listing of beneficiaries who will receive the travel and expenses benefits under the policy. The insurance agent may also help the policyholder or customer 506 define the criteria or trigger event under which the policy may be activated. Depending on what criteria or trigger events are selected, the cost of the policy may be affected accordingly. Other types of trigger events may be used in writing the policy as desired by the policyholder, as long as the underwriter is willing to cover the defined events. For example, other types of trigger events may be a local disaster, sickness of a sibling, or other types of trigger events where the policyholder desires the beneficiary to be able to immediately travel to the location of the policyholder.

The insurance agent or other selling agent can help the policyholder or customer 506 define the payment options under which the closure investment insurance will be paid for. For example, the frequency at which the premiums will be paid can be defined or the length of the closure investment insurance policy can be defined. If the policyholder decides that an investment benefit is also desired with the closure investment policy, then the policyholder can select the investments into which portions of the premiums will be applied.

The method of the present invention can also include issuing an identity card or account card 510 to the beneficiaries, which will aid in fulfilling the policy when the trigger event occurs. This card will generally be issued in advance of the expected event. The identity card can be used in contacting the insurance company or a third party who is administering the benefits under the program.

Eventually, a trigger event will occur 508. Then the policyholder can contact a call center 514. The call center is empowered to receive notice (along with any needed written confirmations) that the trigger event has occurred. The call center or other fulfillment managers are empowered to make the travel arrangements for the claim. This includes making the desired travels plans as quickly as needed by the beneficiaries.

At a later point in time, after the benefits have been used, the beneficiaries can determine whether there are remaining benefits or investments for the policy that are desired to be rolled over 516. As discussed earlier, the roll-over means one or more of the beneficiaries can become the policyholder. This reduces the taxes that might otherwise be attributed to the beneficiaries if the investment funds or other redemption benefits were paid to the beneficiary.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method of providing insurance and financial benefits, comprising:
entering into an insurance contract between a policyholder and an insurance provider;
identifying a beneficiary to be insured under the insurance contract and to receive selected benefits based on a significant health event for the policyholder;
providing the selected benefits to the beneficiary upon an occurrence of the significant health event of the policyholder.

2. A method as in claim 1, wherein the selected benefits are travel expenses and defined expenses that are selected upon entering into the insurance contract.

3. A method as in claim 2, further comprising the step of providing a list of primary beneficiaries designed to receive the travel and defined expenses.

4. A method as in claim 3, further comprising the step of designating alternate individuals, in addition to the list of primary beneficiaries, where the alternate individuals are designated to receive benefits and replace primary beneficiaries who are not able to receive benefits.

5. A method as in claim 1, further comprising the step of investing a portion of premiums paid for under the insurance contract as an investment.

6. A method as in claim 1, further comprising the step of investing a portion of premiums paid for the insurance contract and using a lump sum of investment principle to pay the travel and defined expenses upon the significant health event.

7. A method as in claim 3, further comprising the step of enabling the beneficiary to assume a role of the policyholder after payment of a claim.

8. A method as in claim 1, further comprising the step of adjusting a monetary value of the travel and defined expenses based on an inflation adjustment value.

9. A method as in claim 1, wherein the significant health event is selected from the group consisting of: illness, critical illness, critical accident, incapacitation, and anticipated death.

10. A method as in claim 1, wherein the significant health event is selected from the group consisting of: a defined need to provide care for an individual or a defined need to provide support for an individual.

11. A method as in claim 1, wherein the relationship between the policyholder and beneficiary is a family relationship or business partnership relationship.

12. A method as in claim 1, further comprising applying monthly insurance payments first to pay for insurance coverage and once the insurance coverage has been paid for then the insurance payments are paid to an investment account.

13. A method as in claim 1, further comprising applying a first portion of monthly insurance payments to the pay for insurance coverage and a second portion of the monthly insurance payments to an investment account.

14. A method as in claim 1, further comprising the step of distributing benefits via a benefits manager that administers distribution of the travel expenses and defined expenses.

15. A method of providing insurance and financial benefits, comprising:
executing an insurance contract between a policyholder and an insurance provider, where the insurance contract provides selected travel expenses and defined expenses to a beneficiary to the contract upon a significant health event of the policyholder;
identifying the beneficiary;
paying the selected travel expenses and defined expenses upon an occurrence of the significant health event of the policyholder.

16. A method as in claim 15, further comprising the step of providing a list of primary beneficiaries designed to receive the travel and defined expenses and designating alternate individuals designated to receive benefits and replace primary beneficiaries who are not able to receive benefits.

17. A method as in claim 15, further comprising the step of enabling the beneficiary to assume a role of the policyholder after the significant health event has occurred.

18. A method as in claim 15, wherein the significant health event is selected from the group consisting of: illness, critical illness, critical accident, anticipated death, a defined need to provide care for an individual, and a defined need to provide support for an individual.

19. An insurance system, comprising:
an insurance provider capable of underwriting a closure investment insurance instrument;
a policyholder designated in the closure investment insurance instrument, where the policyholder is capable of purchasing the closure investment insurance from the insurance provider; and
at least one beneficiary designated in the closure investment insurance instrument by the policyholder to receive benefits upon the occurrence of a significant health event.

20. A system as in claim 19, wherein the selected benefits are travel expenses and defined expenses that are selected upon entering the insurance contract.

21. A system as in claim 20, further comprising a benefits manager that administers distribution of the travel expenses and defined expenses for the insurance provider

22. A system as in claim 20, further comprising a credit account that is issued to the beneficiary in order to pay the travel expenses and defined expenses.

23. A system as in claim 20, further comprising a plurality of fulfillment suppliers who are contracted with by the insurance provider to supply contracted travel and additional services.

24. A method of providing insurance and financial benefits, comprising:
entering into an insurance contract between a policyholder and an insurance provider;
identifying a beneficiary to be insured under the insurance contract and to receive travel benefits based on a crisis event for the policyholder;
providing the travel benefits to the beneficiary upon an occurrence of the crisis event for the policyholder.

25. A method as in claim 24, further comprising the step of providing the selected benefits that enable the beneficiary to travel to the policyholder upon the occurrence of the crisis event

26. A method of providing insurance and financial benefits, comprising:
entering into an insurance contract between a policyholder and an insurance provider;
identifying a beneficiary to be insured under the insurance contract and to receive selected benefits based on a death of the policyholder;
providing the selected benefits to the beneficiary upon an occurrence of the death of the policyholder.
